(19) United States
(12) Patent Application Publication
(10) Pub. No.: US 2015/0112768 A1
(43) Pub. Date: Apr. 23, 2015

(54) INFORMATION GATHERING AND PRICE FORECASTING FOR HEAVY EQUIPMENT SALES

(71) Applicant: Craig Klooster, Nashville, TN (US)

(72) Inventor: Craig Klooster, Nashville, TN (US)

(21) Appl. No.: 14/521,366

(22) Filed: Oct. 22, 2014

Related U.S. Application Data
(60) Provisional application No. 61/894,207, filed on Oct. 22, 2013.

(51) Int. Cl. G06Q 30/02

(52) U.S. Cl. CPC G06Q 30/0206
USPC 705/7.35

(57) ABSTRACT

A method for predicting sale prices for heavy equipment products includes presenting, to each of a plurality of users, an indication of a first set of pricing metric data items relating to a market value of a first product and an indication of pricing metric data items for each of a corresponding set of products for the user, receiving, from each user, a forecast price for the first product and a respective estimated price for each of the corresponding set of products for the user, determining a respective forecast rating for each user based on an accuracy assessment of the respective estimated prices received from the forecasting user in view of sale prices of the corresponding set of products for the user, and determining a price prediction for the first product based on the forecast price received from each user weighted according to the respective forecast rating for the user.

### CROSS REFERENCE TO RELATED APPLICATIONS

This application claims the benefit of U.S. Provisional Patent Application Ser. No. 61/894,207, filed Oct. 22, 2013, the contents of which are incorporated herein by reference thereto.

### BACKGROUND OF THE INVENTION

Exemplary embodiments of the present invention relate to information gathering and price forecasting for potential and upcoming sales of heavy equipment products. More specifically, exemplary embodiments relate to spot market price forecasting for heavy equipment products and user price forecast rating assessments that are performed based on crowd-sourced price forecasting.

Heavy equipment, also referred to as heavy machines, encompasses a class of heavy-duty vehicles that are specially designed for executing construction tasks (most often involving earthwork operations). It is estimated that the used heavy equipment and machinery market generates greater than $100 billion in sales annually. Nevertheless, the heavy equipment marketplace is highly fragmented, and only a minimal amount of published data exists.

On any given day, several thousand transactions occur worldwide for used agricultural, construction, mining, logging, and industrial machinery. Primarily, such transactions occur in either a retail setting where an equipment dealer sells equipment to a customer or at an auction event where equipment is sold to the highest bidder among potentially thousands of potential buyers attending the auction in person and online. Individual heavy equipment items regularly sell for prices in excess of $100,000. The sale price between comparable machines (same make, model, and manufacturer year), however, can vary dramatically depending on condition, usage, configuration, and repair requirements, and the sales of machines at such auctions are typically, however, “buyer beware” transactions for which there are no returns. Thus, information on heavy equipment for sale is extremely important to buyers due to the significant cost of purchasing equipment and potential repair costs to make the purchased equipment production ready.

Typically, potential buyers research machines by inspecting them in person at the auction site, prior to the auction. If they are instead monitoring and participating in an auction online, they may use a surrogate to attend the auction in person and inspect the machine for them. It is rare for someone to purchase a machine at such an auction without performing a manual inspection or having highly specific information on the machine.

During the research process, the buyer may record information about the machine and estimate a market price at which they forecast it will sell, which may represent the most the buyer would be willing to pay or expect will be offered for the machine. When determining such market price estimates, buyers will often reference previous auction results accessible through industry content provider websites and publications. The inspection information and forecast price is often jotted down by the buyer within an auction listing brochure that is handed out to buyers prior to the auction and used to follow the auction bidding, and it is also a common practice for buyers to manually record the actual sale price of machines as they are sold as the auction proceeds. Many times, this is simply an activity the buyer engages in to pass time and break monotony during the auction, as heavy equipment auctions are typically long in duration and tedious, and individual buyers are typically interested in purchasing less than five percent of the items for sale at auctions they attend. Because such inspection and pricing information notes are generally handwritten, this information is typically disposed of after the auction event and not leveraged further by the buyer. There is no recognizable incentive for buyers to retain and/or provide such information, and most buyers believe it is in their interest not to share information with outside parties.

### SUMMARY OF THE INVENTION

Exemplary embodiments of the present invention are related to a method for predicting sale prices for heavy equipment products based on crowd-sourced price forecasts. The method comprises providing, at an application server, a network service that is accessible to a plurality of users through a plurality of client systems that are communicatively coupled to the application server via a network and each implementing a client application that provides a user interface for accessing the network service; maintaining, in a data storage system, a past sale record database comprising a plurality of information records respectively associated with a plurality of product sales, where each information record comprises a sale price and a plurality of pricing metric data items relating to a market value of a respective product for the information record; receiving, from one of the client systems being operated by a requesting user to access the network service, a first set of pricing metric data items relating to a market value of a first product; presenting, via the user interface provided by the client application implemented at a corresponding client system of the plurality of client systems being operated by each of a plurality of forecasting users of the plurality of users, an indication of the first set of pricing metric data items and an indication of the plurality of pricing metric data items of each information record of a corresponding set of information records of the plurality of information records for the forecasting user; receiving, from the corresponding client system being operated by each forecasting user, a forecast price for the first product and a respective estimated price for the respective product for each information record of the corresponding set of information records for the forecasting user; determining a respective forecast rating for each forecasting user based on an accuracy assessment of the respective estimated prices received from the forecasting user in view of the sale prices of the corresponding set of information records for the forecasting user; and presenting, via the user interface provided by the client application implemented at the client system being operated by the requesting user, a price prediction for the first product that is determined based on the forecast price received from each forecasting user weighted according to the respective forecast rating for the forecasting user.

Exemplary embodiments of the present invention that are related to computer apparatuses and computer systems corresponding to the above-summarized exemplary embodiments directed to an apparatus are also described and claimed herein.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a schematic diagram illustrating an example network architecture for heavy equipment information and price forecasting system that can be configured to implement exemplary embodiments of the present invention;

FIG. 2a is a screen shot illustrating an example of a price prediction request page provided within a graphical user interface that may be implemented within a client application in accordance with exemplary embodiments of the present invention;

FIG. 2b is a screen shot illustrating an example of a price prediction analysis page provided within a graphical user interface that may be implemented within a client application in accordance with exemplary embodiments of the present invention; and

FIG. 3 is a block diagram of an exemplary computer system that can be used for implementing exemplary embodiments of the present invention.

The detailed description explains exemplary embodiments of the present invention, together with advantages and features, by way of example with reference to the drawings, in which similar numbers refer to similar parts throughout the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered to be within the scope of the claimed invention.

### DETAILED DESCRIPTION

While the specification concludes with claims defining the features of the invention that are regarded as novel, it is believed that the invention will be better understood from a consideration of the description of exemplary embodiments in conjunction with drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form, and it will be apparent to those skilled in the art that the present invention may be practiced without these specific details. Further, the terms and phrases used herein are not intended to be limiting but rather to provide an understandable description of the invention.

Exemplary embodiments of a heavy equipment information clearinghouse and price forecasting system in accordance with the present invention will now be described with reference to the drawings. Exemplary embodiments of the present invention may be implemented to provide a distributed system for data aggregation and crowd sourcing of pricing information within the heavy equipment industry that offers services for searching heavy equipment sale information aggregated from multiple sources and providing spot market pricing for used heavy equipment products with particular sets of attributes. In this regard, exemplary embodiments can be implemented to provide mechanisms for incentivizing individuals to provide price forecasts that are used create a spot market prices for used heavy equipment products. Such spot market pricing data can be valuable to buyers, sellers, and owners of heavy equipment in pricing equipment for purchase or sale or valuing a portfolio of machines for purposes of financing, insurance, liquidation, etc.

Exemplary embodiments may be implemented to provide mechanisms for leveraging the observations of heavy equipment auction attendees to quantify previously qualitative data for the purpose of rating machine market attractiveness and predicting machine sale prices for future sales and for utilizing competitions and incentives that encourage individuals to provide observations that are utilized for determinations of machine sale price predictions. Exemplary embodiments may be implemented to provide mechanisms for rating individuals in terms of the accuracy of their submitted price forecasts and utilizing these ratings of individuals in conjunction with their price forecasts for used heavy equipment products with particular sets of attributes in calculating market price predictions for such heavy equipment products.

It should further be noted that various aspects of exemplary embodiments of the present invention described herein are not limited to systems directed to the field of heavy equipment products but, rather, may be implemented with respect to any suitable classes and types of products and services that may be offered by any suitable classes and types of product sellers or retailers and service providers. Likewise, it is contemplated that other types of revenue-generating transactions may occur for products and services and may be the subject of price prediction analysis in the manner described below. For example, products may be rented, leased, or licensed to a customer under specific terms in exchange for revenue. Thus, the term “sale” may be used herein to generically describe any suitable transaction involving products or services resulting in either direct or indirect (for example, imputed or tangential) revenue, and is intended to encompass rentals, leases, subscriptions, and other types of revenue models.

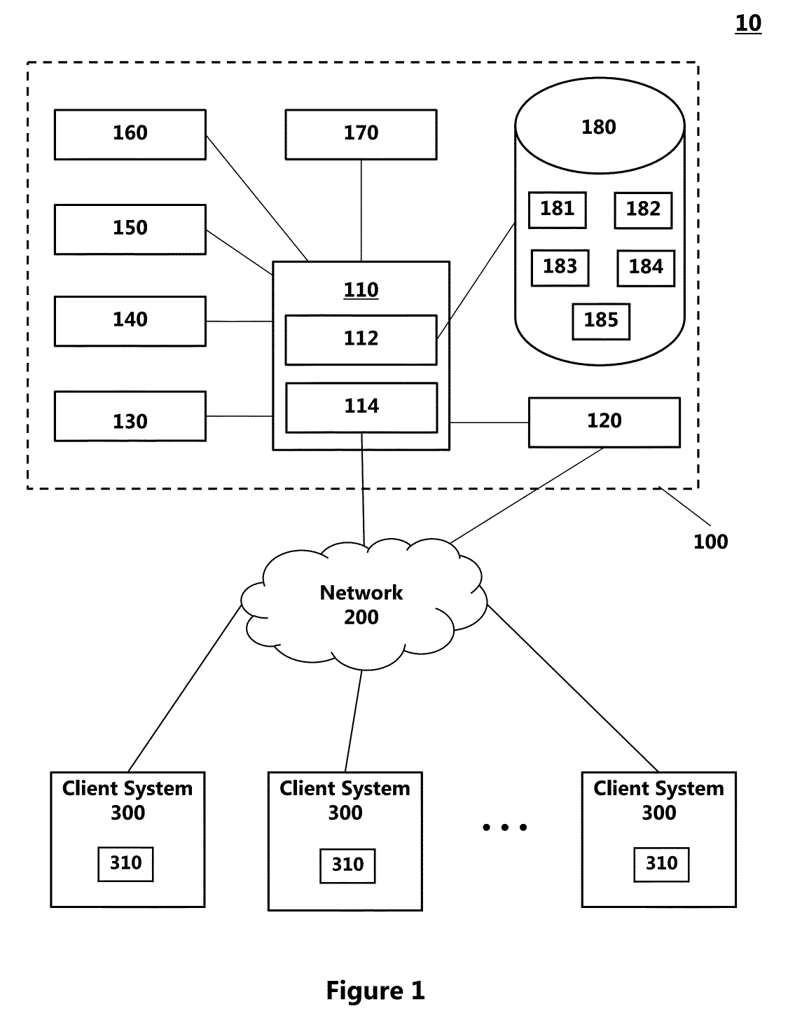

Referring now to FIG. 1, a schematic diagram illustrating an example network architecture for a heavy equipment information and price forecasting system 10 that can be configured to implement exemplary embodiments of the present invention is provided. It should of course be understood that FIG. 1 is intended as an example, not as an architectural limitation for different embodiments of the present invention, and therefore, the particular elements depicted in FIG. 1 should not be considered limiting with regard to the environments within which exemplary embodiments of the present invention may be implemented.

In the example illustrated in FIG. 1, information and price forecasting system 10 is implemented as a client/server system that includes a central server system 100 that provides a set of information and market or sale price prediction services to registered users of the system and is commonly accessed by each user of the system through operation of any of a plurality of client systems 300 that are operatively coupled to the central server system via a communication network 200. As illustrated in FIG. 1, central server system 100 includes a system manager 110 configured to interact with and perform management functions for coordinating operations of the various components and data sources of the server system to provide various services to registered users of the system, a data gathering component 120, a user forecast sourcing component 130, a user assessment component 140, a sale price prediction component 150, a user competition component 160, an award redemption manager 170, and a data store 180.

In the present exemplary embodiment, as will be described in greater detail below, system manager 110 generally includes a database server 112 and an application server 114 for performing the various management functions referenced above, and each client system 300 is a user terminal or other client device implementing software for and running a respective client application 310 for accessing services provided via a network-based application (also referred to herein as a network service) implemented by application server 114. Such client applications may also be referred to as client modules, or simply clients, and may be implemented in a variety of ways. In exemplary embodiments, such client applications can be implemented as any of a myriad of suitable client application types, which range from proprietary client applications (thick clients) to web-based interfaces in which the user agent function is provided by a web server and/or a back-end program (for example, a CGI program).

In exemplary embodiments, information and price forecasting system 10 can include additional servers, clients, and other devices not shown in FIG. 1. The particular architecture depicted in FIG. 1 is provided as an example for illustrative purposes and, in exemplary embodiments, any number of client systems 300 may be connected to server system 100 at any given time via network 200, and server system 100 can comprise multiple server components and databases located within a single server system or within multiple server systems, where the multiple server systems are integrated with or accessible by users of client systems 300 as a distributed server system via network 200.

In exemplary embodiments, network 200 can be configured to facilitate communications between server system 100 and client systems 300, as well as communications with and between other devices and computers connected together within information and price forecasting system 10, by any suitable wired (including optical fiber), wireless technology, or any suitable combination thereof, including, but not limited to, personal area networks (PANs), local area networks (LANs), wireless networks, wide-area networks (WAN), the internet (a network of heterogeneous networks using the Internet Protocol, IP), and virtual private networks, and the network may also utilize any suitable hardware, software, and firmware technology to connect devices such as, for example, optical fiber, Ethernet, ISDN (Integrated Services Digital Network), T-1 or T-3 link, FDDI (Fiber Distributed Data Network), cable or wireless LMDS network, Wireless LAN, Wireless PAN (for example, IrDA, Bluetooth, Wireless USB, Z-Wave and ZigBee), HomePNA, Power line communication, or telephone line network. Such a network connection can include intranets, extranets, and the Internet, may contain any number of network infrastructure elements including routers, switches, gateways, etc., can comprise a circuit switched network, such as the Public Service Telephone Network (PSTN), a packet switched network, such as the global Internet, a private WAN or LAN, a cellular telecommunications network, a broadcast network, or a point-to-point network, and may utilize a variety of networking protocols now available or later developed including, but not limited to the Transmission Control Protocol/Internet Protocol (TCP/IP) suite of protocols for communication.

In exemplary embodiments, database server 112, application server 114, and any other servers employed within server system 100 and third-party servers utilized within information and price prediction system 10 can be implemented within any suitable computing system or systems such as a workstation computer, a mainframe computer, a server system (for example, workstations running the Microsoft Servers line of software and technology, IBM RS/6000 workstations and servers running the AIX operating system, or an IBM zSeries eServer running z/OS, z/VM, or LINUX OS), a server cluster, a distributed computing system, a cloud based computing system, or the like, as well as any of the various types of computing systems and devices described below with reference to client systems 300. Server system 100 may be implemented using any of a variety of architectures. For example, application server 116, database server 112, and the various other components of server system 100 may also be implemented independently or as a single, integrated device. While the exemplary embodiment illustrated in FIG. 1 depicts these components as individual components, the functionalities provided by these components, or various combinations of these functionalities, may actually be provided by server applications running on separate physical devices. In this regard, server system 100 may comprise a number of computers connected together via a network and, therefore, may exist as multiple separate logical and/or physical units, and/or as multiple servers acting in concert or independently, wherein each component may be comprised of multiple separate logical and/or physical units. As one example, although FIG. 1 represents a single system manager 110, a single data gathering component 120, a single user forecast sourcing component 130, etc. for illustrative purposes, it will be appreciated that there may variously be multiple system managers 110, data gathering components 120, user forecast sourcing components 130, etc. to provide redundancy and/or additional capacity. In exemplary embodiments, server system 100 can be connected to network 200 through a collection of suitable security appliances, which may be implemented in hardware, software, or a combination of hardware and software.

In the present exemplary embodiment, as illustrated in FIG. 1, application server 114 is communicatively coupled to database server 112, as well as each of data gathering component 120, user forecast sourcing component 130, user assessment component 140, sale price prediction component 150, user competition component 160, and incentive and redemption manager 170. Database server 112 is connected to data store 180, which comprises a plurality of databases that are maintained by database server 112, accessed by application server 114 via database services provided at a front end by database server 112, and used to store a variety of sets of information on a variety of matters that are utilized in implementing the functions performed by and providing the services offered by the application server, as described below in greater detail.

As used herein, the term “data store,” “data storage unit,” storage device”, and the like can to any suitable memory device that may be used for storing data, including manual files, machine-readable files, and databases. In exemplary embodiments, application server 114, database server 112, and data store 114 may implemented together a single computing device, implemented within a plurality of computing devices locally coupled to each other via a suitable communication medium, such as a serial port cable, telephone line or wireless frequency transceiver, implemented within a plurality of computing devices remotely coupled to each other via network 200, or any suitable combination thereof.

Client systems 300 are computer devices to which one or more users, who may be seeking to access services provided by central server system 100 as, for example, heavy equipment item price forecasters or persons seeking to request price forecasts for heavy equipment items, have access. It should be noted that the term “user” is used herein to refer to one who uses a computer system, such as one of client systems 300. As described in greater detail below, client systems 300 are each operable by such users to access server system 100 via network 200 and act as clients to access services offered by the network service provided by the server system within exemplary information and price prediction system 10. For this purpose, each client system includes a respective client application 310 that executes on the client system and allows a user to interact with server system 100 via application server 114.

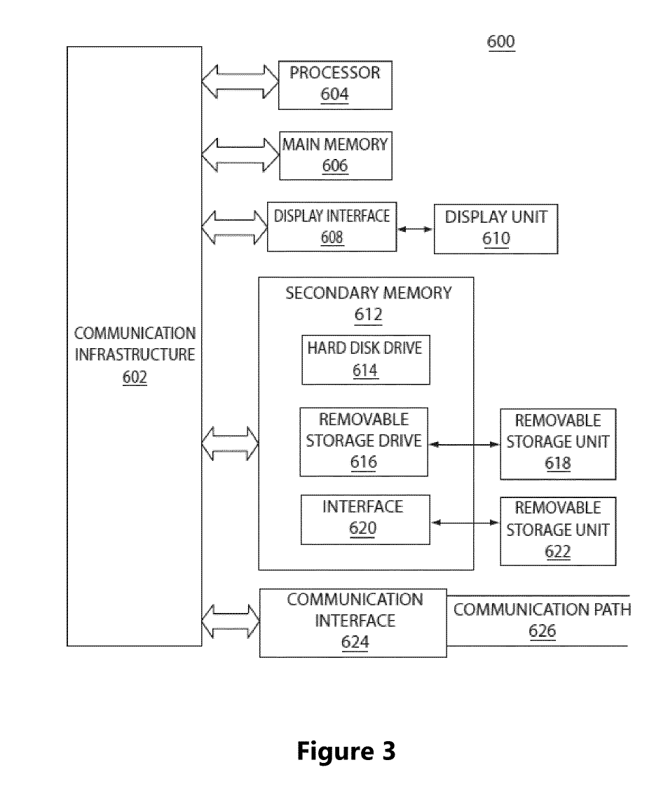

In exemplary embodiments, the computer systems of client systems 300 can be any of a wide range of suitable computing devices such as one or more workstations, desktop computers, laptops, or other personal computers (PCs) (for example, IBM or compatible PC workstations running the MICROSOFT WINDOWS operating system or LINUX OS, MACINTOSH computers running the MAC OSX operating system, or equivalent), non-traditional-computer digital devices such as Personal Digital Assistants (PDAs) and other handheld or portable electronic devices, smart phones and other mobile handsets, tablet computers, netbook computers, game consoles, home theater PCs, desktop replacement computers, and the like, or any other suitable information processing devices. An exemplary computer system for client systems 300 is described in greater detail below with reference to FIG. 3.

In general, during operation of exemplary information and price prediction system 100, a client system 300 first establishes a connection to server system 100 via network 200. Once the connection has been established, the connected client system may directly or indirectly transmit data to and access content from the application server 114. A user accessing application server 114 through the connected client system can thereby to use a client application 310 executing on the connected client system to access services provided by the application server, which are described in greater detail below, via a user interface implemented at the client application within which the client application renders the information served by the application server.

In exemplary embodiments, application server 114 can implement the network service as a non-web client application (such as a mobile application), a web client application, or both to provide the services accessed by client systems 300 within server system 100, and client applications 310 can correspondingly be implemented as non-web client applications, web client applications, or both for operation by users of the client systems to interact with application server 114 and access the services provided thereby. For example, application server 114 can comprise a web server configured to provide a web application for the respective client applications implemented on client systems 300 that are configured to provide web-based user interfaces for utilizing the services provided by the web server. For instance, the user interfaces implemented within client applications 310 executing on client systems 300 can be configured to provide various options corresponding to the functionality offered in exemplary embodiments described herein through suitable user interface controls (for example, by way of menu selection, point-and-click, dialog box, or keyboard command). In one general example, the user interfaces may provide “send” or “submit” buttons that allow users of client applications to transmit requested information to application server 114. The user interfaces can be implemented, for example, as a graphical user interface (GUI) that renders a common display structure to represent the network service provided by application server 114 for a user of a client system.

More specifically, in such an example, application server 114 can, for example, be configured to provide services via a web-based software application hosting a corresponding website that includes a number of web pages (e.g., screens), and client applications 310 can comprise a web browser executing on client systems 300, such that the services provided by application server 114 are accessible to client systems 300 using the Internet or an intranet. Users of client systems 300 may thereby access the website provided by application server 114 by, for example, inputting or following a link to the uniform resource locator (URL) for the website in the web browser, which then enable users to display and interact with information, media, and other content embedded within the web pages of the website provided by application server 114. The web-based software application can transmit information that can be processed by the web browsers to render a user interface using, for example, a browser-supported programming languages such as JavaScript, HTML, HTML5, and CSS, or the like, and can communicate with the web browsers using, for example, HTTPS, POST and/or GET requests. Client applications 310 and application server 114 may be configured so that information transmitted between client systems 300 and server system 100 can be encrypted and sent over a secure network connection to protect, for example, user privacy and confidential information, and server system 100 may be located behind a firewall with respect to the client systems.

As will be described in greater detail throughout the discussion provided below, system manager 110 is configured to facilitate user access to services provided by server system 100 and to monitor and dynamically manage an overall information state of server system 100. For this purpose, system manager 110 is configured to utilize database server 112 to maintain and access various types of information records within the plurality of databases of data store 180. Each of the plurality of databases can comprise, for example, a structured relational database that includes one or more database tables, each of which is a data structure logically in the form of a table having multiple information records. An information record (which may also be referred to an entry or a table) may be, for example, a program and/or data structure that tracks various data related to a corresponding type of information record, with each information record having one or more (typically multiple) fields (also referred to as attributes). As used herein, the terms “data,” “content,” “information” and similar terms may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

In the present exemplary embodiment, the plurality of databases that are maintained within data store 180 via database server 112 include a user account database 181, a past sale record database 182, a forecasted sale item database 183, a user competition database 184, and one or more additional databases 185 that may be used for storing any other suitable information that may be utilized by server system 100 (for example, system usage data, audit trail data, data used internally within the system by system manager 110, and the like). In exemplary embodiments, the various databases maintained within data store 180 can be maintained as groups within one or more larger databases or maintained individually.

In the present exemplary embodiment, user account database 181 is used to maintain account information records for users that register with server system 100 to forecast prices for heavy equipment items and/or request price forecasts for heavy equipment items. For each user for which an account is registered with server system 100, various items of information relevant to the user, such as name, contact information, billing information, and any other suitable identifying information, as well as a unique user name and password associated with the account that can be used to log into the account, can be included in the respective account information record for the user that is maintained within user account database 181. Moreover, the respective account information record for each user that is maintained within user account database 181 can include additional fields for maintaining information that is populated based on various interactions the user engages in with the system in association with the user account over time, such as price forecasts submitted by the user for heavy equipment products for which information pertaining thereto is maintained in forecasted sale item database 183, an award points balance, indications of services and prizes acquired by the user using accumulated award points, user forecast rating information (which may include items indicative an overall forecast rating for the user, forecast ratings for the user respective to particular categories and manufacturers of heavy equipment, number of price forecasts submitted by the user, etc.), references to certain heavy equipment products and auctions for which information pertaining thereto is maintained in past sale record database 182 and forecasted sale item database 183 that the user has indicated a desire to follow or has submitted a request for a price forecast, references to user price forecast competitions for which information pertaining thereto is maintained in user competition database 184 and in which the user is participating or has participated, and privacy settings specifying whether particular items of information maintained in the respective account information record for the user are visible to other users of server system 100. Descriptions of how the information included in these additional fields in the respective account information record for each user that is maintained within user account database 181 is populated and utilized within server system 100 will be provided in greater detail below. Additionally, if various services offered by server system 100 are provided for a fee, the respective account information record for each user that is maintained within user account database 181 may also contain billing and payment information for the user, although such information may also be maintained separately. The respective account information record for each user within user profile database 181 can further include a unique user account identifier that is used by system manager 110 in performing various operations.

Past sale record database 182 is used to maintain information records describing past sales of heavy equipment items based on information obtained by data gathering component 120 (as will be described in greater detail below). For each individual heavy equipment item sale for which an information record in maintained in past sale record database 182, various items of information relevant to the sale, such as a particular retailer or auction through which the item was sold, the price at which the item was sold, a date and location at which the item was sold, a particular category of heavy equipment for the item sold, information relating to the market value of the item at the time of the sale, which may be collectively referred to as “pricing metrics” and include details pertaining to the item such as serial number, make and/or manufacturer, model, manufacture year, machine hours, configuration, observed condition description and/or rating, observed hours, predicted hours, original equipment manufacturer (OEM) delivered specifications, original list price, and the like, and any other suitable identifying information may be included in the respective information record for the sale. The respective information record for each individual heavy equipment item sale within past sale record database 182 can also include a date at which the information record was added to the database and a unique item sale identifier that is used by system manager 100 in performing various operations.

Forecasted sale item database 183 is used to maintain information records describing potential and upcoming sales of heavy equipment items based on information obtained by data gathering component 120 and forecast requests submitted by users to server system 100 (as will be described in greater detail below). For each individual heavy equipment item for which an information record in maintained in forecasted sale item database 183, various items of information relevant to a possible sale of the item, such as a particular retailer or auction through which the item is being sold, a location of the particular retailer or auction, an auction date if the item is listed to be sold at an auction, a particular category of heavy equipment for the item, pricing metric information relating to the present market value of the item, which may include details pertaining to the item such as serial number, make and/or manufacturer, model, manufacture year, machine hours, configuration, observed condition description and/or rating, observed hours, predicted hours, original equipment manufacturer (OEM) delivered specifications, original list price, and the like, and any other suitable identifying information may be included in the respective information record for the item. The respective information record for each individual heavy equipment item within forecasted sale item database 183 can also include a date at which the information record was added to the database, the unique user account identifier for the respective account information record within user profile database 181 for the user that submitted a forecast request for the item (if such a forecast request was submitted by a user), the unique user account identifier for the respective account information record within the user profile database for each user that has submitted a forecast price for the item along with the forecast price submitted by the user (and any condition rating submitted by the user), and a unique item identifier that is used by system manager 100 in performing various operations.

User competition database 184 is used to maintain information records describing user price forecast competitions for sales of heavy equipment items that are implemented via user competition component 160 within server system 100 (as will be described in greater detail below). For each individual user price forecast competition for which an information record in maintained in forecasted sale item database 183, various items of information relevant to the competition, such as descriptions of particular parameters of the competition (for example, rules, scoring, dates, the unique item sale identifiers for the respective information records within past sale record database 182 for any individual heavy equipment item sales for which forecast prices are submitted in the competition, the unique item identifiers for the respective information records within forecasted sale item database 183 for any individual heavy equipment items for which forecast prices are submitted in the competition, etc.), indications of a particular auction and auction date if the competition is associated with a particular auction, indications of prize and/or point amounts to be awarded, an indication of whether the competition is open to all registered users of server system 100 or participation is limited to closed set of registered users, the unique user account identifier for the respective account information record within the user profile database for each registered user of server system 100 that is participating in the competition, the forecast prices submitted by each user participating user for each item or item sale for which price forecasts are submitted in the competition, details pertaining to user standings for the competition, an indication of a stage at which the competition is at or whether the competition is completed, and any other suitable descriptive information may be included in the respective information record for the competition. The respective information record for each user price forecast competition within user competition database 184 can also include a unique competition identifier that is used by system manager 100 in performing various operations.

In the present exemplary embodiment, as illustrated in FIG. 1, data gathering component 120 of central server system 100 is communicatively coupled to system manager 110. As noted above, data gathering component 120 is configured to gather data for creating and populating respective information records within past sale record database 182 for past sales of individual heavy equipment item and respective information records within forecasted sale item database 183 for potential and upcoming sales individual heavy equipment items. In exemplary embodiments, to obtain this data, data gathering component 120 can be configured to collect heavy equipment item information and corresponding sale information from one or more public and private data sources, which may include including heavy equipment auction organizations, auction listing brochures, heavy equipment sale data collection organizations, industry content provider websites and publications, or any other suitable sources of information. For example, there are a number of industry specific websites and publications that provide Historical Auction Price (HAP) information for machines that are being sold or have been sold at public heavy equipment auctions. A typical set of HAP information for a machine include descriptions that include pricing metric information for the machine along with, if the auction at which the machine is sold has been completed, an observed sale price of the machine. Examples of such websites that provide HAP information include Machinery Trader (machinerytrader.com), Ritchie Bros. Auctioneers (rbauction.com), and Rock & Dirt (rockanddirt.com).

In exemplary embodiments, data gathering component 120 can be configured to obtain the information for creating and populating respective information records within past sale record database 182 for past sales of individual heavy equipment items and respective information records within forecasted sale item database 183 for potential and upcoming sales individual heavy equipment items from data sources automatically (for example, by accessing and retrieving information directing from various online data sources via network 200) as well as via manual entry by a back-end administrator of server system 100. Data gathering component 120 can be further configured to analyze and arrange or otherwise convert the obtained data (which may be obtained, for example, in a raw text format) into a standard format that is used for the information records within past sale record database 182 and forecasted sale item database 183 (for example, using various industry specific abbreviations for describing model, age, usage, configuration, condition, and the like of heavy equipment items that facilitates effective querying of the information records). Upon the obtained data being arranged in the corresponding format employed within server system 100, data gathering component 120 can then submit the formatted data to system manager 110, which can be configured to, in response to receiving the formatted data, utilize database server 112 to create and populate the corresponding information records within past sale record database 182 and forecasted sale item database 183. In this manner, server system 100 operates to aggregate heavy equipment item information and corresponding sale information from multiple data sources within a single data repository.

As discussed above, application server 114 can implement a user interface so that users of client systems 300 that are connected to server system 100 via network 200 can access various services provided by the application server with relative ease by operating a corresponding client application 310. In exemplary embodiments, the user interface can be a web-based user interface, implemented as a web-based software application hosting a corresponding website that provides a number of web pages (that is, screens) to offer the services implemented by application server 114 to users. For example, a user can access the corresponding website using a web browser implemented within a client application 310 executing on a client system 300.

In exemplary embodiments, when any user, regardless of whether the user is registered with server system 100 or a non-registered user, operates a client system 300 to access application server 114 (for example, by launching a native client application or by using a web browser to submit a URL that provides a network address for the application server), the application server can be configured with a default setting that directs the user to a home page, at which the user is presented with various options accessible through interface elements within the user interface implemented by the virtual application server to access registration and login functions provided by the application server 114.

Thus, in such embodiments, application server 114 can be implemented to require a user to first register with server system 100 and thereby establish a respective account information record within user account database 181 to be able to access the various user services offered by server system 100. In exemplary embodiments, application server 114 can be implemented to provide a respective set of services for each of various types of users (which may include, for example, unregistered guests, “forecaster” user that register with server system 100 to access services associated with submitting price forecasts for heavy equipment items, and “requestor” users that register with server system 100 to access services associated with requesting price predictions for particular heavy equipment items specified by the user), and some of the services offered by the application server can be commonly applicable to and accessible by all types of users, while other services can be applicable to and accessible only by specific types of users or by users that have been granted specific access rights. In exemplary embodiments, the particular client applications 310 or the particular client systems 300 that are utilized for accessing server system 100 can be respective to and customized for each type of user account. For example, the particular client application that is utilized for particular types of users can be implemented to a provide virtual computing platform that is specific to the services offered for that type of user. For purposes of illustration, the descriptions of exemplary embodiments of the present invention provided below will generally be described in terms of a single type of registered user that is generally able to access both services associated with both submitting price forecasts for heavy equipment items and services associated with requesting price predictions for particular heavy equipment items specified by the user, as well as various other user services offered by application server 114.

In the present exemplary embodiment, the user interface element within the default home page implemented by application server 114 that provides an option to register with server system 100 may be, for example, provided as a “Register an account” button rendered at the client application. In exemplary embodiments in which application server 114 is implemented to provide respective sets of services for different types of users, application server 114 may be configured to provide additional user interface controls for allowing the user to specify a type of user account that the user intends to register with server system 100. Upon the user indicating an intention to register with server system 100, the user will be able to initiate a registration session with application server 114 to register an user account with server system 100. For this purpose, application server 114 may be configured to implement a series of pages with user interface controls that are accessible by the user to guide the user through the account registration process and prompt the user to input various types of user account information such as, for example, name, contact information, billing information, and any other suitable identifying information, and to access database server 112 to create a respective account information record for the user to be maintained within user account database 181 based on this information input by the user during the registration process. Application server 114 can be further configured to generate the unique user account identifier for the created account information record, which may be used, for example, to index and reference the created account information record within user account database 181. The respective account information record for a user that is established within user account database 181 can further include a unique user name and protected by a password, which can be used by the user to log into the user account when accessing server system 100 over network 200. Additional security mechanisms could also be implemented by application server 114 during the registration process for access to and/or protection of information, such as challenge questions, encryption keys for encrypting sensitive data, etc.

Upon a user registering a user account with server system 100 to establish an account information record and operating a client application executing on a client system to log into his or her customer account (for example, by accessing a login user interface element or a login screen within the user interface implemented by application server 114 to provide the user name and password associated with the account), the user can then presented with various options accessible through interface elements within the user interface implemented by the application server to access the various services provided by the application server in association with the respective user account for the user with server system 100.

More particularly, in various general examples, application server 114 can be configured to implement user interface controls within a number of interactive screens that are accessible by the user to perform management functions such as editing of profile data and preferences, search the information records maintained within past sale record database 182 for information pertaining to past sales of individual heavy equipment items and forecasted sale item database 183 for information pertaining to potential and upcoming sales of individual heavy equipment items according to a specific set of attributes specified by the user and review the information, accumulate points that can redeemed for prizes and awards within server system 100 through functions implemented by award redemption manager 170 by submitting price forecasts or estimates for individual heavy equipment items for which information records are maintained in forecasted sale item database 183 and individual heavy equipment item sales for which information record are maintained in past sale record database 182, participate and compete with other users in forecast pricing competitions administered by user competition component 160 for individual heavy equipment items for which information records are maintained in forecasted sale item database 183 and individual heavy equipment item sales for which information record are maintained in past sale record database 182, and submit requests for sport market price predictions for individual heavy equipment items having a particular set of attributes specified by the user.

In exemplary embodiments, system manager 110 can be configured to facilitate and direct various operations that performed within server system 100 in conjunction and/or to assist with providing these services such as, for example, transmitting requests generated by user forecast sourcing component 130 to registered users for price forecasts for particular individual heavy equipment items for which information records are maintained in forecasted sale item database 183 and individual heavy equipment item sales for which information record are maintained in past sale record database 182, directing user assessment component 140 to determine price forecast ratings for registered users based on price forecasts or estimates submitted by the users, directing sale price prediction component 150 to determine spot market price predictions for individual heavy equipment items for which information records are maintained in forecasted sale item database 183 as a function of price forecasts submitted by the users for the items in conjunction with corresponding price forecast ratings determined by the users, storing determined spot market price predictions for individual heavy equipment items in the respective information records that are maintained for the for individual heavy equipment items in forecasted sale item database 183 to allow for this information to be included with returned search results.

In exemplary embodiments, server system 100 can be implemented to provide mechanisms for incentivizing registered users to operate client systems 300 to connect to server system 100 via network 200 and access application server 114 via client applications 310 executing on the client system to submit sale information observed at auction events to the server system via the user interface implemented by application server. In a typical, but non-limiting, implementation, the client systems that are utilized to submit such observed sale information at auction will be mobile devices. System manager 110 can be further configured to award a set amount of points to the award points balance in the respective account information record for a user that is maintained within user account database 181 in response to receiving auction sale information submitted from the user via application server 114. Moreover, system manager 110 can be configured to, in response to application server 114 receiving auction sale information for particular individual heavy equipment items for which information records are maintained in forecasted sale item database 183, create corresponding information records for individual heavy equipment item sales and utilize database server 112 to access past sale record database 182 to store the newly create information records. System manager 110 can also be configured to, in response to application server 114 receiving auction sale information for particular individual heavy equipment items for which information records are maintained in forecasted sale item database 183, retrieve the unique user account identifier for each user that has submitted a forecast price for the items along with the forecast price submitted by the user from the information records for the particular individual heavy equipment items and provide this information along the reported sale prices to user assessment component 140 to use in calculating user forecast rating information for the user (which may include items indicative an overall forecast rating for the user, forecast ratings for the user respective to particular categories and manufacturers of heavy equipment, number of price forecasts submitted by the user, etc.).

In exemplary embodiments, user assessment component 140 can be configured to, for calculating user forecast rating information for a user, compare the forecasted prices with actual sales prices to assess the accuracies of the forecasts submitted by the user. In exemplary embodiments, the user forecast rating information calculation that is performed by user assessment component 140 for a user can be based on total number of items for which the user submits price forecasts and the assessed accuracies of the forecasts submitted by the user. In exemplary embodiments, the user forecast rating information that is calculated for each user can include an overall forecast rating for the user as well as specific forecast ratings for the user that are respective to particular categories of heavy equipment and particular manufacturers of heavy equipment.

In exemplary embodiments, user competition component 160 can be configured to administer competitions among users based on heavy equipment items that are being sold at a particular auction event to elicit price forecasts from users that are utilized by the system to accumulate user forecast data for calculating user forecast rating information for the participating users based on the observed sales prices for the forecasted items sold at auction at the completion of the auction. In particular, respective information records can be maintained within forecasted sale item database 183 for each or a particular set of the individual heavy equipment items that are being sold at a particular auction event in association with the auction event, and user competition component 160 can be implemented to direct system manager 110 to, via application server 114, transmit requests to users participating in the auction-based competition to provide a forecast price (and, optionally, a machine rating) for each auction item prior to it being sold at auction via a connected client system 300 and, upon the item being sold during the auction, to provide the observed sales price for an item sold at auction via a connected client system 300. User competition component 160 can further be configured to direct user assessment component 140 to calculate user forecast rating information for each user participating in the auction by comparing the forecasted prices with actual sales prices of the forecasted auction items to assess the accuracies of the forecasts submitted by the user with respect to the auction and then determine the user forecast rating information calculation for each participating user based on total number of items for which the user submits price forecasts and the assessed accuracies of the forecasts submitted by the user. The calculated participating user rating information for each user participating in the auction can be rendered within the user interface implemented by application server 114 for registered users accessing server system 100 to view.

In exemplary embodiments, user forecast sourcing component 130 can be configured to provide opportunities for users to accumulate award points within their respective user account information records that can redeemed for prizes and awards within server system 100 through functions implemented by award redemption manager 170 by submitting price forecasts for individual heavy equipment items for which information records are maintained in forecasted sale item database 183 and price estimates individual heavy equipment item sales for which information record are maintained in past sale record database 182. In exemplary embodiments, system manager 110 can be configured to award points to users based on both the number of items for which each user submits price forecasts or estimates and the assessed accuracies of the price estimates submitted by each user. As described in greater detail below, the assessed accuracies of the price estimates submitted by each user for individual heavy equipment item sales for which information record are maintained in past sale record database 182 can be utilized by server system 100 in calculating user forecast rating information for the user, and the price forecasts submitted by users for individual heavy equipment items for which information records are maintained in forecasted sale item database 183 can be utilized by server system 100 in calculating spot market price predictions for the individual heavy equipment items that can be provided to registered users in association with other information that is maintained in forecasted sale item database 183 for the individual heavy equipment items when such information is returned in response to registered users operating a client application 310 to access the user interface controls implemented by application server 114 to search the information records maintained within forecasted sale item database 183 for information pertaining to potential and upcoming sales of individual heavy equipment items.

In exemplary embodiments, user forecast sourcing component 130 can be configured to provide such opportunities for users within a competition administered by user competition component 160 in which users compete for award points based on the accuracy of their price forecasts over as a specified period of time. Such competitions can include a set number of rounds during each of which a plurality of price forecasts are requested from the user, be repeating, and can have, for instance, monthly, weekly, and/or daily winners. In one example, users can be presented with a set number of descriptions of individual heavy equipment items for which information records are maintained in forecasted sale item database 183 and the user is requested to provide price forecasts and descriptions of individual heavy equipment item sales for which information record are maintained in past sale record database 182 to evaluate per round and the user is requested to provide price estimates. The information included in the descriptions can be presented to users based on industry-standard formats. This information can be presented to the users, for example, via a web-form that is implemented by application server 114 within client applications 310 being operated by the users to access server system, and may not necessarily specify whether particular descriptions for which price forecasts are being requested are sourced from forecasted sale item database 183 or past sale record database 182. In this manner, the users will be unaware of whether their submission for each requested price forecast will be used in determining user forecast rating information based on a comparison with an actual sale price for a past individual heavy equipment item sale or used in determining price forecasts for possible or upcoming sales of individual heavy equipment items.

In exemplary embodiments, each round during which a set of descriptions are provided at a single time for users to submit price forecasts can be active for a specified period of time after which the opportunity for users to submit price forecasts expires. Such rounds can be initiated, for example, via either a “pull” method, which is initiated by each participating user when the user logs in to server system 100 and access user interface controls implemented by application server 114 to request to receive descriptions and provide corresponding price forecasts for the round, or a “push” method, which is initiated via a notification transmitted to the users, for example, via text messages and/or email messages (utilizing the contact information maintained the user account information records for the users in user account database 181) indicating there are machine descriptions awaiting their evaluation. Such electronic notifications may include a hyperlink to a web-form implemented by application server 114 that presents descriptions and includes user interface controls allowing users to submit corresponding price forecasts for the round.

In exemplary embodiments, such a web-form can be implemented to receive user-submitted price in any suitable form. For example, the web-form can be implemented to provide a multiple-choice format that allows users to select from a plurality predetermined price forecasts or to provide a manual entry field that requires the users to determine a specific price forecast. Upon a user selecting or entering price forecasts and submitting the price forecasts for a round (for example, by clicking a “submit” button), user assessment component 140 can calculate a user accuracy score for the user for the round, which application server 114 can then transmit to the client system being operated by the user for rendering within the user interface. At the completion of each round, the scores for the registered users participating in the competition can be updated and these scores can be presented in a standings table for the competition that is accessible via the user interface implemented by application server 114. In exemplary embodiments, once price forecasts are submitted by a user for particular descriptions, the price forecasts cannot be changed or edited by the user.

In exemplary embodiments, the particular calculation of a user accuracy score for a user for each round can be calculated by user assessment component 140 can be specific to the form in which the price forecasts are submitted by users. In one example, for a multiple choice format, three selections can be presented to users for each description: 1) an actual recorded price at which the machine sold for which a user receives a maximum amount of points for selecting; 2) a randomly generated price that is within a defined percentage of the machine sale price for which a user receives a lesser point amount for selecting; and 3) a randomly generated price that is outside a defined percentage of the machine sale price which a user receives no points for selecting. In another example, for a manual entry format, a user can receive points based on the accuracy of price forecasts in comparison to actual recorded sales prices. More specifically, in this example, if the price forecast entered by the user is within a narrowly defined percentage of the actual recorded sales price, the user receives a maximum number of points, if the price forecast entered is within an expanded percentage of the actual recorded sales price, the user receives a lesser amount of points, and if the price entered is outside the expanded percentage of the actual recorded sales price, the user receives no points.

In exemplary embodiments, user forecast sourcing component 130 can further be configured to provide other manners of opportunities for users to accumulate award points by submitting price forecasts for individual heavy equipment items for which information records are maintained in forecasted sale item database 183 and price estimates individual heavy equipment item sales for which information record are maintained in past sale record database 182. For example, individual users registered with server system 100 can submit requests via the user interface implemented by application server 114 for system manager 110 to direct user forecast sourcing component 130 to periodically generate and provide the user with machine descriptions and requests for price forecasts from the user via which the user can accumulate award points (which can be awarded to the user by the system manager based on the user submitting price forecasts and/or an assessed accuracy of the submitted price forecasts). In exemplary embodiments, users can further specify particular categories for which they want to receive machine descriptions for price forecasting in association with the request or elect to receive randomly selected descriptions from all categories.

As noted above, application server 114 can also be configured to implement user interface controls within a number of interactive screens that are accessible by a user operating a client application 310 to access server system 100 to submit requests for sport market price predictions for individual heavy equipment items having a particular set of attributes specified by the user. More particularly, when a user selects an option provided within the user interface to submit a request for a spot market price prediction, application server 114 can be configured to direct the user to a price prediction request page that includes a plurality of user input fields in a predefined fillable form that the user can complete and submit to register the request with server system 110. The plurality of user input fields included in such a predefined fillable form can correspond to various items of information that are included in an information record for an individual heavy equipment item that is maintained in forecasted sale item database 183 (for example, the pricing metric information as described above).

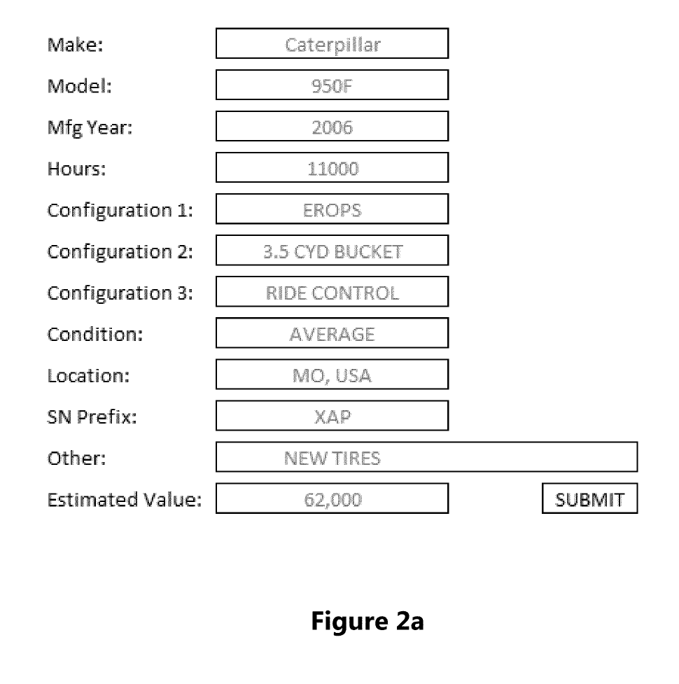

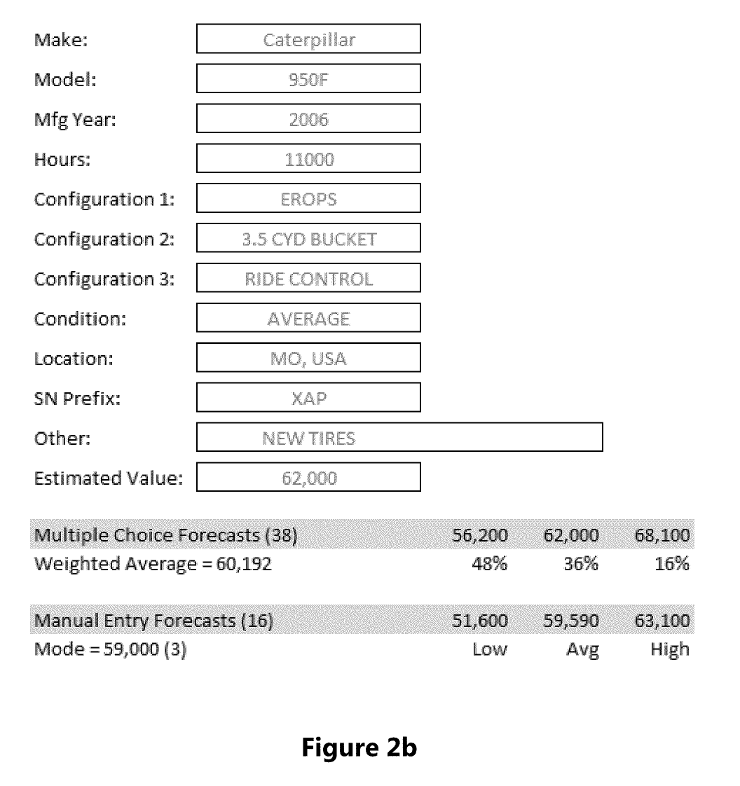

FIG. 2a is a screen shot illustrating an example of such a predefined fillable form provided within a graphical user interface (GUI) that is implemented for such a price prediction request page. In this example, the requesting user is responsible for describing the machine and providing their own estimation of the machine value. Upon submitting the request form, system manager 110 can utilize database server 112 to access forecasted sale item database 183 to create a corresponding information record for an individual heavy equipment item to be maintained within the database. In this regard, the created information record can then be utilized by user forecast sourcing component 130 to request price forecasts from other registered users of server system 100 based on a description of the individual heavy equipment item, and, upon a sufficient number of price forecasts being received from the other registered users, system manager 110 can be configured to direct sale price prediction component 150 to determine a price prediction for the individual heavy equipment item based on the received price forecasts to return to the requesting user. In exemplary embodiments, user forecast sourcing component 130 can be configured to direct requests for price forecasts that are generated based on individual heavy equipment items for which a user has requested a spot market price prediction to particular registered users that have been determined by user assessment component 140 to have high forecast ratings for corresponding categories or corresponding manufacturers of heavy equipment items. As other registered users submit their price forecasts in response to requests generated user forecast sourcing component 130, system manager 110 can transmit notifications to the requesting user providing updates regarding the price prediction request. The price prediction determined based on accumulated price forecasts can provide the requesting user with an opportunity to analyze the accuracy of their own estimation of the machine value in comparison with that determined based on the crowd-sourced price forecast. In this regard, FIG. 2b is a screen shot illustrating an example of a price prediction analysis page that is implemented within a GUI and provided for such a purpose.

In exemplary embodiments, the estimation of the machine value submitted by the requesting user can be utilized as the reference point against which the price forecasts submitted by other registered users will be compared. That is, In either case, the machine value estimate submitted by the requesting user will be considered to be the machine sale price for the purposes of creating selections for multiple choice format requests, scoring the received price forecasts, and awarding points to the price forecasting users. Some price forecasting users may receive the corresponding price forecast request in manual entry format and while others may receive the price forecast request in multiple choice format.

As also noted above, application server 114 can be configured to implement user interface controls within a number of interactive screens that are accessible by the user to search the information records maintained within past sale record database 182 for information pertaining to past sales of individual heavy equipment items and forecasted sale item database 183 for information pertaining to potential and upcoming sales of individual heavy equipment items according to a specific set of attributes specified by the user and review the information. In exemplary embodiments, application server 114 can be configured to provide search services allowing for users to conduct searches for both upcoming auction events and across multiple upcoming auction events for machines that correspond to a set of attributes specified by the user and will be sold at the upcoming auction events.

The parameters that can be specified by a user in a search for upcoming auction events can include, for example, a date range (such as within the next 30 days), a particular auctioneer, and a particular location. The results for such an upcoming auction event search can be returned and provided to the user as a list of upcoming auctions that match the specified search parameters and include respective user interface controls that are accessible by a user to view a listing of all heavy equipment items that are to be sold at each auction event included in the list. In this regard, application server 114 can be further configured to implement user interface controls allowing a user view more information pertaining to each heavy equipment item listed for a selected auction listing, submit requests to follow particular auctions included in the returned list of upcoming auction, submit requests to follow particular heavy equipment items listed for a selected auction listing, and submitting price forecasts, machine ratings, or other descriptive information with respect to individual heavy equipment items listed for a selected auction listing for which information records are maintained in forecasted sale item database 183. Such price forecasts submitted by users through this functionality can be handled by server system 100 in a similar manner to the exemplary embodiments described above with reference to price forecasts received from users in response to requests generated by user forecast sourcing component 130. For example, users can submit such price forecasts to accumulate award points. Information pertaining to particular heavy equipment items and particular auctions for which a user has selected to follow can be made accessible to the user via user interface controls included within a respective user home page that is accessible through the user interface implemented by application server 114 when the respective user is logged in to server system 100.

The parameters that can be specified by a user in a search across multiple upcoming auction events for machines that correspond to a set of attributes specified by the user and will be sold at the upcoming auction events can include, for example, a date range (such as within the next 30 days), a particular manufacturer, a particular heavy equipment category, and a particular model. The results for such an upcoming auction event search can be returned and provided to the user as a list of machines for sale at upcoming auctions that match the specified search parameters and include respective user interface controls that are accessible by a user to view more information pertaining to each heavy equipment item listed in the search results, submit requests to follow particular heavy equipment items listed in the search results, and submitting price forecasts, machine ratings, or other descriptive information with respect to individual heavy equipment items listed in the search results for which information records are maintained in forecasted sale item database 183. Such price forecasts submitted by users through this functionality can be handled by server system 100 in a similar manner to the exemplary embodiments described above with reference to price forecasts received from users in response to requests generated by user forecast sourcing component 130. For example, users can submit such price forecasts to accumulate award points.

As also noted above, system manager 110 can be configured to direct user assessment component 140 to determine price forecast ratings for registered users based on price forecasts or estimates submitted by the users and direct sale price prediction component 150 to determine spot market price predictions for individual heavy equipment items for which information records are maintained in forecasted sale item database 183 as a function of price forecasts submitted by the users for the items in conjunction with corresponding price forecast ratings determined by the users. In this regard, because server system 100 can be expected to continually receive or determine new information that is used to calculate price forecast ratings for registered users and calculate spot market price predictions for individual heavy equipment items, in exemplary embodiments, system manager 110 can be configured to update the calculations of price forecast ratings for registered users and spot market price predictions for individual heavy equipment items in response to each time such new information is received or determined. For example, system manager 110 can be configured to direct user assessment component 140 to update user forecast rating information for a registered user each time an accuracy assessment is performed for a price forecast submitted by the user (which may occur, for instance, when the user submits a price forecast for an individual heavy equipment item sale for which an information record in maintained in past sale record database 182 or when a sale is reported for an individual heavy equipment item for which an information record in maintained in forecasted sale item database 183 and for which the user has previously submitted a price forecast). As another example, system manager 110 can be configured to direct sale price prediction component 150 to update the spot market price prediction for a particular individual heavy equipment item whenever a new price forecast is received for the item from a registered user or whenever user forecast rating information is updated for a registered user that has submitted a price forecast that is included in the calculation of the spot market price prediction for the particular individual heavy equipment item. In such embodiments, the state of the price forecast ratings for registered users and the spot market price predictions will reflect a real-time or near real-time state of server system 100. In other exemplary embodiments, system manager 110 can be configured to direct such update calculations to be batched and processed in groups at specified intervals, such as hourly or daily.

In exemplary embodiments, the calculation performed by sale price prediction component 150 to determine the spot market price prediction for an individual heavy equipment item for which an information record is maintained in forecasted sale item database 183 can be based on a mathematical model that assigns a weight to each price forecast submitted by a registered user being utilized in the calculation based on the respective user forecast rating information for the user. In this regard, the weight can be assigned to the price forecast submitted by a user based on, for example, an overall forecast rating for the user, a forecast rating for the user that is respective to a corresponding heavy equipment category, or a forecast rating for the user that is respective to a corresponding heavy equipment manufacturer. In exemplary embodiments, the calculation performed by sale price prediction component 150 to determine the spot market price prediction for an individual heavy equipment item can be further based on various items of pricing metric information relating to the individual heavy equipment item.

Exemplary embodiments of the present invention can thereby be implemented to provide users with access to comprehensive data related services to aid in evaluating heavy equipment machines by providing industry-specific, standardized functionality and services that allow users to research machines, enter and aggregate data, and share information with other users. Exemplary embodiments can provide a scalable mechanism for aggregating a more comprehensive database of auction sales information that is available to users without the users having to attend an auction event than previously available in the prior art, and sale information for auctions can be provided by any user at any auction occurring any place in the world via a network-connected device. In exemplary embodiments, in addition to the breadth of auction results, the accuracy of recorded results will be higher since multiple observations of the same machine are provided.

Exemplary embodiments of the present invention can further be implemented to foster an interactive user community that produces machine specific information, available nowhere else, that can be utilized specifically by the community and the industry in aggregate. In this regard, exemplary embodiments can be implemented to allow for creation of social networks so that some information can be shared only between “friends” or colleagues, whereas other information is available to the community at large. Forecasters can compete against all other auction attendees in an “Open” competition as described above or they can invite peers to compete in a “Closed” competition. Such closed competitions can also be used by an individual to keep track of just their own forecasts and auction results. Open and Closed competitions vary in terms of rules. For example, an Open competition may require that all forecast prices be entered before an auction event starts while a Closed competition allows users to enter forecast prices while an auction is ongoing. An Open competition may generate points that are redeemable for prizes with server system 100, while any prizes associated with a Closed competition are the responsibility of the peers involved in the Closed event. Open and Closed competitions may utilize the same scoring processes.

Exemplary embodiments of the present invention can further be implemented to, in addition to determining and updating user forecast rating information for respective registered users, also determine and update rankings of registered users relative to one another based on the user forecast rating information. For example, system manager 110 can be configured to direct user assessment component 140 to create and maintain an overall user rankings based on volume of observations, accuracy in predicting sales price, and accuracy in rating machines, and, additionally, to create and maintain specific user rankings for heavy equipment categories, manufacturers, product types, etc. In exemplary embodiments, such rankings can be generated based on forecasts submitted during a defined period of time (for instance, annually, monthly or weekly), and a user may be required to provide a minimum amount of observations for a defined period to be ranked. Users ranked by forecast accuracy ranking may be displayed prominently within the user interface implemented by application server 114 for all users of server system 100 to view.

In exemplary embodiments, individual user home pages implemented by application server 114 for respective users can provide a display of ranking positions, accumulated award point, and a “peer” list. The peer list can be accessible within the user interface implemented by application server 114 to support social media functionality that allows a user to interact with other user to comment on their standing, challenge to individual completion, etc.

In exemplary embodiments, award redemption manager 170 can be configured to provide access to additional services and promotional items for highly-rated users. For instance, users achieving “Expert” status (that is, the highest ranked users) can be granted access to additional services on the site and awarded promotional items.

Exemplary embodiments of the present invention can provide implement mechanisms that are distinctly different from prior art models currently utilized to forecast used heavy equipment prices in a number of important ways: 1) Improved timeliness, by collecting spot market prices at the time they are requested; 2) improved accuracy and consistency, by eliciting pricing for the exact description of a machine being valued; 3) increased number of observations; and 4) quantifiable statistical relevance, by generating significantly more observations for a machine described in the same manner to all of a large number of price forecast providers to thereby greatly increases the statistical relevance of the valuation.

Aspects of exemplary embodiments of the present invention described herein can be implemented using one or more program modules and data storage units. As used herein, the term “modules”, “program modules”, “components”, “systems”, “tools”, “utilities”, and the like include routines, programs, objects, components, data structures, and instructions, or instructions sets, and so forth that perform particular tasks or implement particular abstract data types. As can be appreciated, the modules refer to computer-related entities that can be implemented as software, hardware, firmware and/or other suitable components that provide the described functionality, and which may be loaded into memory of a machine embodying an exemplary embodiment of the present invention. Aspects of the modules may be written in a variety of programming languages, such as C, C++, Java, etc. The functionality provided by modules used for aspects of exemplary embodiments described herein can be combined and/or further partitioned.

As used herein, the terms “data storage unit,” “data store”, “storage unit”, and the like can refer to any suitable memory device that may be used for storing data, including manual files, machine readable files, and databases. The modules and/or storage units can all be implemented and run on the same computing system (for example, the exemplary computer system illustrated in FIG. 3 and described below) or they can be implemented and run on different computing systems. For example, one or modules can be implemented on a personal computer operated by a user while other modules can be implemented on a remote server and accessed via a network.

In exemplary embodiments, the client applications utilized in exemplary embodiments of the present invention can be configured for incorporation within any suitable network computing environment as a plug-in, add-on, or extension. As used herein, the term “plug-in” can refer to a software application or module program, or one or more computer instructions, which may or may not be in communication with other software applications or modules, that interacts with a host application to provide specified functionality, and which may include any file, image, graphic, icon, audio, video, or any other attachment. In other exemplary embodiments, the client applications can be implemented as a standalone program that is run as a separate computer process, a portable application, a part of a software bundle, or any other suitable implementation.

In the preceding description, for purposes of explanation, numerous specific details are set forth in order to provide a thorough understanding of the described exemplary embodiments. Nevertheless, one skilled in the art will appreciate that many other embodiments may be practiced without these specific details and structural, logical, and electrical changes may be made.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: (a) conversion to another language, code or, notation; and (b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 3 is a block diagram of an exemplary computer system 600 that can be used for implementing exemplary embodiments of the present invention. Computer system 600 includes one or more processors, such as processor 604. Processor 604 is connected to a communication infrastructure 602 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 600 can include a display interface 608 that forwards graphics, text, and other data from the communication infrastructure 602 (or from a frame buffer not shown) for display on a display unit 610. Computer system 600 also includes a main memory 606, which can be random access memory (RAM), and may also include a secondary memory 612. Secondary memory 612 may include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, removable storage unit 618 includes a computer usable storage medium having stored therein computer software and/or data.

In exemplary embodiments, secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (that is, channel) 626. Channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface including a wired network or a wireless network that allow a computer to read such computer readable information.

Computer programs (also called computer control logic) are stored in main memory 606 and/or secondary memory 612. Computer programs may also be received via communications interface 624. Such computer programs, when executed, can enable the computer system to perform the features of exemplary embodiments of the present invention as discussed herein. In particular, the computer programs, when executed, enable processor 604 to perform the features of computer system 600. Accordingly, such computer programs represent controllers of the computer system.

While the invention has been described in detail with reference to exemplary embodiments, it will be understood by those skilled in the art that various changes and alternations may be made and equivalents may be substituted for elements thereof without departing from the scope of the invention as defined by the appended claims. In addition, many modifications may be made to adapt a particular application or material to the teachings of the invention without departing from the essential scope thereof.

Variations described for exemplary embodiments of the present invention can be realized in any combination desirable for each particular application. Thus particular limitations, and/or embodiment enhancements described herein, which may have particular limitations need be implemented in methods, systems, and/or apparatuses including one or more concepts describe with relation to exemplary embodiments of the present invention.

Therefore, it is intended that the invention not be limited to the particular embodiments disclosed as the best mode contemplated for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. §112, sixth paragraph, unless the element is expressly recited using the phrase “means for” or “step for.” These following claims should be construed to maintain the proper protection for the present invention.

What is claimed is:

1. A method for predicting sale prices for heavy equipment products based on crowd-sourced price forecasts, the method comprising:
providing, at an application server, a network service that is accessible to a plurality of users through a plurality of client systems that are communicatively coupled to the application server via a network and each implementing a client application that provides a user interface for accessing the network service;
maintaining, in a data storage system, a past sale record database comprising a plurality of information records respectively associated with a plurality of product sales, where each information record comprises a sale price and a plurality of pricing metric data items relating to a market value of a respective product for the information record;
receiving, from one of the client systems being operated by a requesting user to access the network service, a first set of pricing metric data items relating to a market value of a first product;
presenting, via the user interface provided by the client application implemented at a corresponding client system of the plurality of client systems being operated by each of a plurality of forecasting users of the plurality of users, an indication of the first set of pricing metric data items and an indication of the plurality of pricing metric data items of each information record of a corresponding set of information records of the plurality of information records for the forecasting user;
receiving, from the corresponding client system being operated by each forecasting user, a forecast price for the first product and a respective estimated price for the respective product for each information record of the corresponding set of information records for the forecasting user;
determining a respective forecast rating for each forecasting user based on an accuracy assessment of the respective estimated prices received from the forecasting user in view of the sale prices of the corresponding set of information records for the forecasting user; and
presenting, via the user interface provided by the client application implemented at the client system being operated by the requesting user, a price prediction for the first product that is determined based on the forecast price received from each forecasting user weighted according to the respective forecast rating for the forecasting user.
